(19) United States
(12) Patent Application Publication
(10) Pub. No.: US 2009/0292915 A1
(43) Pub. Date: Nov. 26, 2009

(54) NETWORK SYSTEM AND DEVICE SETTING METHOD OF NETWORK SYSTEM

(75) Inventor: Shoichi SAKANE, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/470,173

(22) Filed: May 21, 2009

(30) Foreign Application Priority Data
May 22, 2008 (JP) 2008-133745

(51) Int. Cl. G06F 15/173; G06F 17/30; H04L 29/06

(52) U.S. Cl. 713/155; 709/225; 707/3; 707/E17.014; 709/229

(57) ABSTRACT

Disclosed is a network system including: a provisioning server to provide setting information to a device newly connected to a network; and a mediating device to mediate information transmission between the device newly connected to the network and other device, wherein the mediating device includes: a communication function to communicate with the device newly connected to the network; an access control function to restrict access to the other device to a certain amount or less; and a data transfer function to transfer data, and when there is a transfer request of the setting information from the device newly connected to the network, the mediating device sends the transfer request to the provisioning server by restricted access based on the access control function, and when the setting information is sent from the provisioning server, the mediating device transfers the setting information to the device newly connected to the network.

### BACKGROUND OF THE INVENTION

1. Field of the Invention

The present invention relates to a network system where a plurality of devices operate by performing communication with each other through a network and a device setting method to perform setting so that a device newly connected to the network system can participate in the network.

2. Description of Related Art

In a large scale facility such as plants, a large number of devices are provided and these devices are communicably connected to each other through a network to compose a network system. The above described device includes various devices such as measuring devices for example, thermometer, hygrometer, flow meter, etc., and driving devices for example, heater switch, driving motor of flow rate adjusting valve, etc.

Each device composing such network system is internally provided with a communication circuit to be able to connect to the network, micro-computer to perform operation control, etc., and is installed with software to operate in conjunction with other devices.

In such network systems, the operation parameter of each software needs to be adjusted for each device so that each device operates in coordination with each other. Such operation parameters are typically determined by simulation, etc. before actually providing the device.

Also, a communication network composing a network system may include various topologies or connection types with various communication methods (for example, connection type with various wired methods such as 10Base-T or 100Base-T, connection type with various wireless methods, etc.) may be mixed. Therefore, when each device is connected to the network, the network parameter needs to be set to enable sending and receiving of data according to the position provided. Also, in wireless connection, there are cases where the communication sensitivity cannot be predicted beforehand due to influence of a building, etc., and thus the network parameter is adjusted after the device is actually provided.

In other words, before operation, parameters generally classified in the following two types A and B need to be set for the plurality of devices composing the network system:
A. Parameter to define operation of software implemented in each device so that the plurality of devices operate together in coordination with each other;
B. Network parameter to enable communication through the entire network or between some of the devices.

Conventionally, such parameter setting of a network system has been usually performed manually by an operator.

Also, as a conventional technique related to the present invention, there is a disclosure of the following technique. Specifically, there is a technique such as, in a network system where a large number of devices are wirelessly connected divided in a plurality of groups, the setting operator can visually check the information concerning association of the devices and thus the operation of collecting network information beforehand for grouping is unnecessary (for example, Japanese Patent Application Laid-Open Publication No. 2006-287787).

There is a problem that, with the conventional method, performing parameter setting of a large number of devices manually by the operator requires a great amount of labor and time. For example, in order to set a parameter in a device, a setting tool to perform parameter setting by inputting and outputting electric signals to the device needs to be used. However, in order to perform parameter setting of a large number of devices provided by various vendors, the number of necessary setting tools also becomes large, and the operator needs to perform setting operation carrying all of these setting tools. Consequently, the operation becomes very troublesome.

Also, there is a problem that since the operation is performed manually, there is a relatively large possibility that a mistake occurs, such as mistaking the device and the parameter.

Therefore, the inventors of the present invention studied whether the parameter setting of each device can be performed by communication through a network when the device connects to the network. For example, as shown in FIG. 15, while connecting a provisioning server (PVS) 81 storing setting parameters of each device to the network, each device 86 includes a function to perform a request to the provisioning server 81 to transfer a setting parameter when newly connected to the network and a function to change its setting status with the setting parameter when the setting parameter is transferred from the provisioning server.

With this structure, since the setting parameters of a large number of devices can be collectively managed by the provisioning server 81 and the device 86 can automatically download the setting parameter by connecting to the network and perform its parameter setting, it was conceived that setting operation would not be troublesome and highly reliable setting processing where a mistake hardly occurs would be possible.

However, with a method as shown in FIG. 15, it was conceived that the following problem would occur. First, as in a case such as when a large number of devices 86, 86, and so on whose parameters are not set are connected to the network region 89b where the provisioning server 81 is present, when parameter transfer requests R1, R1, and so on from the large number of devices 86, 86 and so on are intensively sent to the provisioning server 81, there is a problem that an excessive burden is placed on the network path in between and the provisioning server 81. Since there may be a network system, etc. of another plant between the network region 89a, 89a to where the devices 86, 86, and so on performing parameter setting are connected and the provisioning server 81, when an excessive burden is placed on one network path, there is a possibility that this interferes with operation of another network system. Therefore, when parameter setting of the large number of devices 86, 86 and so on is performed by one provisioning server 81, it was conceived that the burden concentrating on the network needed to be avoided.

Also, a network system may include various topologies or connection types with various communication methods in a mixed state and there are cases where the network parameter concerning communication sensitivity of wireless communication (for example parameter of communication frequency band, etc.) cannot be predicted until the device is actually provided, and thus there is a problem that all setting parameters cannot be prepared beforehand. Therefore, with a method of providing all setting parameters from a provisioning server to each device, providing the network parameter which is determined when the device is provided is difficult.

### SUMMARY OF THE INVENTION

It is, therefore, a main object of the present invention to provide a network system which can perform parameter setting on a plurality of devices composing a network system by setting processing through a network without placing an excessive burden on the network path or the server, where the processing is performed with high reliability and without the necessity of troublesome operation. Another object of the present invention is to provide a setting method of the device.

Yet another object of the present invention is to provide a network system which can perform parameter setting by setting processing through a network even if a suitable value of a network parameter cannot be predicted without providing the device, where the processing is performed with high reliability and without the necessity of troublesome operation. Another object of the present invention is to provide a setting method of the device.

According to an aspect of the present invention, there is provided a network system where a plurality of devices operate by performing communication with each other through a network, the network system including:

a provisioning server to provide setting information to a device newly connected to a network; and

a mediating device to mediate information transmission between the device newly connected to the network and other device, wherein

the mediating device includes:
a communication function to communicate with the device newly connected to the network;
an access control function to restrict access to the other device to a certain amount or less; and
a data transfer function to transfer data by mediating the device newly connected to the network and the other device, and

when there is a transfer request of the setting information from the device newly connected to the network, the mediating device sends the transfer request to the provisioning server by restricted access based on the access control function, and when the setting information is sent from the provisioning server, the mediating device transfers the setting information to the device newly connected to the network.

According to another aspect of the present invention, there is provided a device setting method in a network system where a plurality of devices operate by performing communication with each other through a network, the device setting method which performs setting to allow a newly connected device to participate in the network with automatic control operation by the newly connected device, provisioning server to provide setting information of the device, and mediating device to mediate information transmission between the device and the provisioning server, the device setting method including:

connecting the device newly connected to the network communicably with the mediating device previously connected to the network;

performing transfer request of the setting information by the device communicably connected to the mediating device;

sending the transfer request of the setting information to the provisioning server by the mediating device in a status restricting the access amount to a certain amount or less;

sending the setting information by the provisioning server through the mediating device to the device based on the transfer request; and

changing a setting status based on the setting information by the device which receives the setting information through the mediating device.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is a diagram showing an example of a structure of a network system according to a first embodiment;

FIG. 2 is a sequence diagram showing a flow of operation from when a field device is newly connected to the network to when setting information is reflected to the field device;

FIG. 3 is an explanatory diagram showing an example of switching of a connection status between the field device and the network;

FIG. 4A and FIG. 4B are explanatory diagrams showing an example of an operation when a function as an access point is added to the field device;

FIG. 5 is a diagram showing an example of a structure of a network system according to a second embodiment;

FIG. 6 is a sequence diagram showing a flow of operation from when a field device is newly connected to the network to when setting information is reflected to the field device according to the second embodiment;

FIG. 7 is an explanatory diagram showing an example of switching of a connection status between the field device and the network according to the second embodiment;

FIG. 8A and FIG. 8B are explanatory diagrams showing an example of an operation when a function as an access point is added to the field device according to the second embodiment;

FIG. 9 is a diagram showing an example of a structure of a network system according to the third embodiment;

FIG. 10 is a sequence diagram showing a flow of operation from when a field device is newly connected to the network to when setting information is reflected to the field device according to the third embodiment;

FIG. 11A is an explanatory diagram showing a first pattern of an example of collection pattern of router list information by the field device in a network of wired communication;

FIG. 11B is an explanatory diagram showing a second pattern of an example of collection pattern of router list information by the field device in a network of wired communication;

FIG. 11C is an explanatory diagram showing a third pattern of an example of collection pattern of router list information by the field device in a network of wired communication;

FIG. 12 is an explanatory diagram showing an example of collection pattern of information of communication sensitivity by the field device in a network of wireless communication;

FIG. 13 is an explanatory diagram showing an example of switching of a connection status between the field device and the network according to the third embodiment;

FIG. 14A and FIG. 14B are explanatory diagrams showing an example of an operation when a function as an access point is added to the field device according to the third embodiment; and

FIG. 15 is a diagram explaining an example of study concerning a method of collectively performing device setting processing through a network.

### DESCRIPTION OF THE PREFERRED EMBODIMENTS

The best mode for carrying out the network system and device setting method of the network system according to the present invention will be explained in detail with reference to the drawings. However, the scope of the invention is not limited to the illustrated examples.

An embodiment of the present invention will be described with reference to the drawings.

### First Embodiment

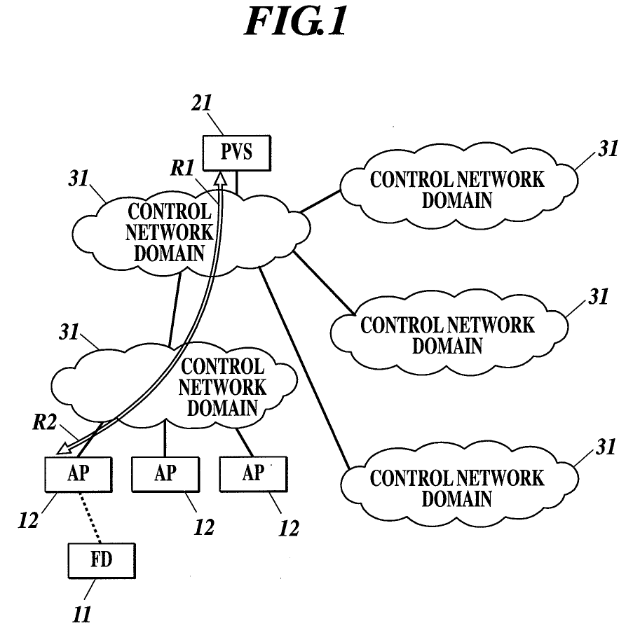

FIG. 1 is a diagram showing an example of a structure of a network system according to a first embodiment.

As shown in FIG. 1, the network system of the present embodiment includes, for example, a large number of field devices 11 provided in control equipment such as a plant, etc., provisioning server (PVS) 21 to perform management and provision of a parameter of the field devices 11, one or a plurality of access points 12 as a relay device to be first connected to communicate when a field device 11 is newly connected to the network, and the like.

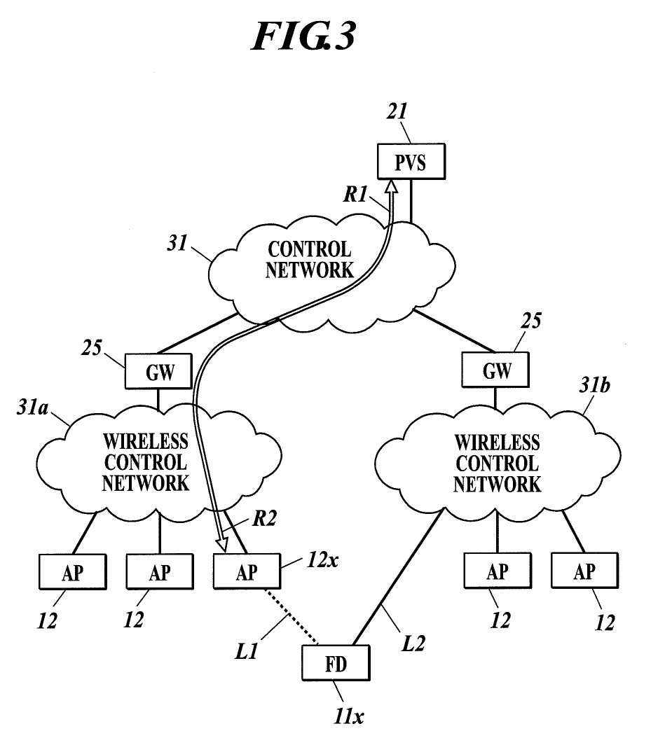

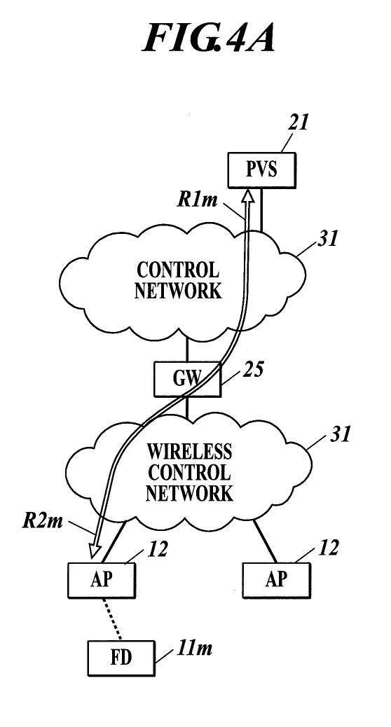

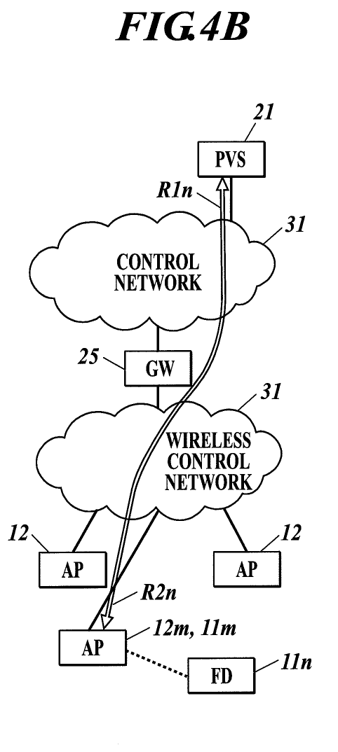

A plurality of field devices 11 and access points 12 may be connected by grouping according to each network region 31 or may be connected by distributing to a plurality of network regions 31. Here, network region 31 represents a partitioned region for management of a network, for example, as shown in FIG. 3 or FIG. 4, domain partitions connected to each other through a gateway 25, partition according to method of communication, etc.

The provisioning server 21 is usually connected to a network region 31 different from the plurality of field devices 11 and access points 12. For example, the field device 11 is provided in the network region 31 in the plant facility while the provisioning server 21 is provided in a network region 31 provided in a control room, management center separate from the plant, etc. Incidentally, the provisioning server 21 may be connected to the same network region 31 as the field device 11 or the access point 12. Also, the provisioning server 21 may not be connected to the network all the time, and may be connected only when a new network system is constructed or a new field device 11 is added and may be separated from the network during the rest of the time.

The field device 11 includes various devices such as measuring devices for example, thermometer, hygrometer, flow meter, etc., and driving devices for example, heater switch, driving motor of flow rate adjusting valve, etc.

In addition to the structure to implement the above described device function, the field device 11 includes a communication module to perform sending and receiving of data through the network and microcomputer to generally control the device. The microcomputer is provided with a nonvolatile memory (storage section) to store various software modules and various control data such as setting parameter, a Central Processing Unit (CPU) to perform software, and the like.

As for the software module included in the field device 11, in addition to the device control module to perform control operation as a device function (measuring function, driving function, etc.) in coordination with other devices and data communication, the software module includes, automatic link module which automatically establishes a communication link with an access point on the network to be in a communicable status (for example, a status where communication is possible only one to one), parameter request module to output transfer request of setting information including various parameters at initial connection, automatic setting change module to write the setting information in the nonvolatile memory and to change its setting status when the setting information is received at initial connection, and the like.

The provisioning server 21 includes a CPU to perform general control of the apparatus, communication module to perform communication through the network, storage device including a setting information database accumulated with setting information of the large number of field devices 11, and the like. Also, as software modules which the CPU performs, the provisioning server 21 includes, a response module to respond to the transfer request of setting information, database management module including a search function to search and retrieve setting information corresponding to the specified initial device ID from the setting information database, and the like.

The setting information database is accumulated with operation parameter of each field device 11 determined beforehand by simulation, etc. by a system designer, network parameter fixed to allow each field device 11 to participate in the network, and the like.

The access point 12 is a device to mediate information transmission between the field device 11 newly connected to the network and the provisioning server 21, and the access point 12 includes a communication module to perform communication through the network, microcomputer to perform general control of the devices, and the like. The microcomputer is provided with various software modules, a CPU to perform the software and the like.

The software module included in the access point 12 includes, an automatic link module which automatically establishes a communication link with a field device 11 newly connected to the network to be in, for example, a one to one communicable status, data transfer module to perform data transfer between the field device 11 newly connected and other devices, and access control module to restrict access to other devices by the data transfer module to a certain amount or less. For example, the access control module allows one access for every certain amount of time by a count of the inner clock or allows access for every certain amount of time according to the content of the transfer data, the data length, or the like. When access request of the above amount or more is sent from the field device 11, the access request is abandoned and an error notification is sent to the field device 11 or the access request is held until the next access timing and then the access request is transferred.

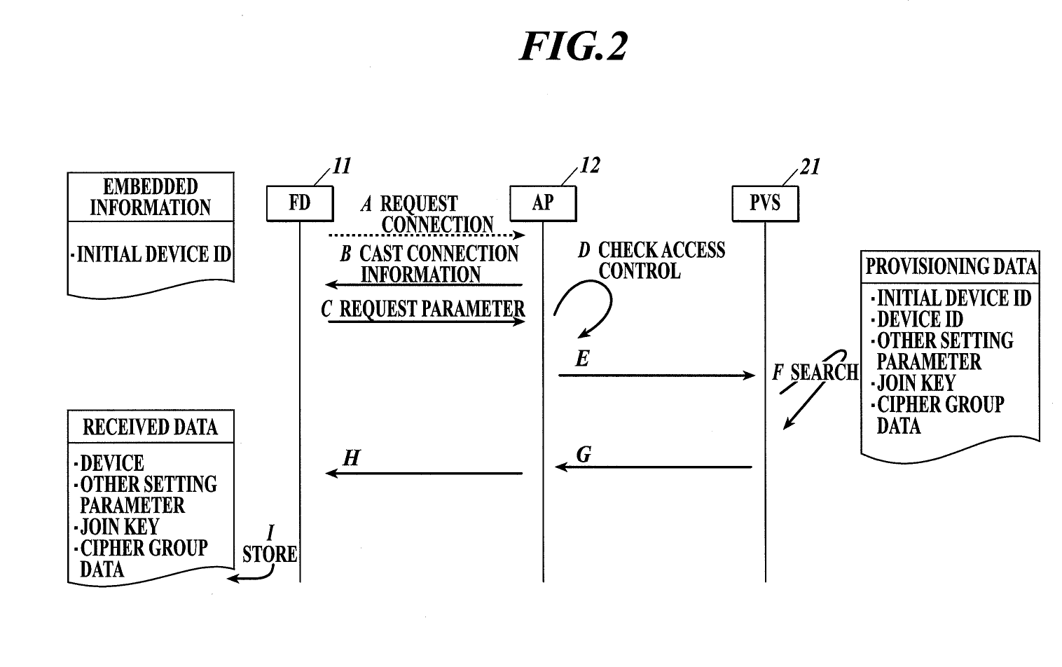

FIG. 2 is a sequence diagram showing a flow of operation from when the field device 11 is newly connected to the network to when setting information is reflected to the field device 11.

In order to allow the field device 11 to participate in the network, first, the initial information (embedded information shown in FIG. 2) is set before the field device 11 is provided. The initial status includes the initial device ID (identification information) to identify each device in setting processing. The initial information is stored in a predetermined region of the nonvolatile memory of the field device 11.

Also, the setting information database of the provisioning server 21 is registered with the initial device ID of each field device 11 and the initial device ID and the setting information are corresponded to each other.

In the network system of the present embodiment, for example, when an operator provides the field device 11 at a predetermined position of the plant facility, connects the field device 11 to the network and turns the power on, the processing operation of A to I shown in FIG. 2 is performed and the setting processing of the field device 11 is performed automatically. Next, the processing operation of A to I is described.

First, as for A, when the field device 11 connects to the network, the automatic link module of the field device 11 operates to send from the field device 11 to an unspecified device on the network a connection request to establish a communication link with the access point 12. Incidentally, the connection request can be omitted by using a communication method where the access point 12 periodically sends initial network connection information to unspecified devices without waiting for a connection request.

As for B, when the above described connection request is received, or by a periodical operation, the access point 12 sends out initial network connection information (for example broadcast) to the unspecified large number of devices on the network to establish the communication link with the newly connected field device 11 by the operation of the automatic link module. The initial network connection information includes, for example, address of the access point, connection key, network address which the field device 11 assigns to itself, etc. The network address which the field device 11 assigns to itself is for example, the initial address allocated by the Dynamic Host Configuration Protocol (DHCP) in the case of Internet Protocol (IP) connection, initial address which is not routed extracted from a reserved address pool, link local address communicable only within a single LAN, and the like.

Then, when the field device 11 receives the initial network connection information, the field device 11 performs connection setting based on the information to establish a communication link to be able to communicate data with the access point 12.

As for C, when the communication link with the access point 12 is established, the field device 11 sends a transfer request (parameter request) of the setting information with its initial device ID to the access point 12.

As for D, when the access point 12 receives the above described parameter request, the access point 12 examines with the access control module whether or not it is a status where access to the provisioning server 21 can be performed. Then, when it is not the access timing, access to the provisioning server 21 is not performed and is on standby until the access timing.

As for E, when it is the access timing based on the access control, the access point 12 transfers the parameter request, including the initial device ID, received from the field device 11 to the provisioning server 21 through the network (parameter request R1 shown in FIG. 1).

As for F, when the provisioning server 21 receives the above described parameter request, the provisioning server 21 performs a search processing in the setting information data base based on the initial device ID and extracts setting information corresponding to the initial device ID.

As for G, when the setting information is extracted, the provisioning server 21 creates a response message including the setting information as provisioning data and sends the response message to the access point 12 (message response R2 shown in FIG. 1). The provisioning data includes, for example, initial device ID showing a transfer destination, device ID to be identification information in participation of the network, and other parameters such as operation parameters of the application, network parameter necessary for network connection, and the like. Also, key data (join key) necessary to participate in the network system, or if cipher communication is necessary, cipher group data (called cipher suite: list of encryption algorithm and the like) to perform cryptographic processing may be included in the provisioning data to be sent from the provisioning server 21.

As for H, when the access point 12 receives the above response message, the access point 12 sends the response message to the corresponding field device 11 based on the initial device ID included as the destination in the response message.

As for I, when the field device 11 receives the response message from the access point 12, the field device 11 reads out the setting information included in the response message, writes the information in its setting region of the nonvolatile memory and reflects the information to its setting status. With this, for example, the ID of the field device 11 is rewritten from the initial device ID to the device ID assigned by the provisioning server 21, and also the network parameter is provided to the communication module and the operation parameter of the software is provided to each software and is respectively reflected to the operation status. With this, the field device 11 can communicate with other devices through the network, and can operate the device function in coordination with other devices.

With the processing operation of the above described A to I, when one field device 11 is connected to the network, the setting processing of the field device 11 is automatically performed, and the field device 11 performs the predetermined functional operation on the network system. Also, when a large number of field devices 11, 11 and so on are similarly connected to the network, similar processing operation is performed for each field device 11, and the necessary setting are automatically performed for all of the field devices 11, 11 and so on registered to the provisioning server 21. Also, at this time, the parameter requests from the large number of field devices 11, 11 and so on are distributed according to time, by the access control of the access point 12, and thus an excessive burden is not placed on the network path between the field device 11 and the provisioning server 21.

FIG. 3 is an explanatory diagram showing an example of switching of a connection status between the field device 11 and the network.

Also, according to the above described setting processing of the field device 11, as shown in FIG. 3, communication path L1 where a field device 11x established a link for setting processing and communication path L2 where the field device 11x is connected to the network according to the network parameter supplied from the provisioning server 21 are different.

As an example, in the setting processing, the field device 11x accidentally receives ahead the initial network information from the access point 12x of the network region 31a and with this, the field device 11x establishes a communication link with the access point 12x of the network region 31a at the path L1.

Also, the system designer designs the system so that the field device 11x performs communication processing belonging to a different network region 31b and registers the network parameter for this purpose in the setting information data base of the provisioning server 21.

In this case, the field device 11x sends the parameter request and receives the response message through the communication path L1 first established, and when the network parameter included in the response message is reflected to its setting status, the setting of the status of the communication module is changed by the network parameter so that data communication belonging to the network region 31b is possible, and therefore after the setting change, the communication processing is performed through the communication path L2 connected to the network region 31b. For example, as shown in FIG. 3, in network regions 31a, 31b where each device is connected in a wireless communication method, the communication path L1 before setting and the communication path L2 after setting can be changed across different network regions 31a, 31b.

FIG. 4A and FIG. 4B are explanatory diagrams showing an example of an operation when a function as an access point is added to the field device.

Also, by installing in the field device 11 in advance a software module to operate to function as the above described access point 12, after the field device 11 participates in the network through the setting processing, the field device 11 can operate as a device with both the function as the field device 11 and the function as the access point 12.

For example, in the field device 11m shown in FIG. 4A, in addition to software such as the device control module to implement the above described device function (measuring function, driving function, etc.), a first automatic link module to establish the communication link with the access point 12 in the setting processing, and parameter request module and automatic setting change module necessary for setting processing, in order to mediate setting processing of a different newly connected device as the access point 12, the field device 11m is previously installed with a second automatic link module to establish the communication link with the newly connected device, and data transfer module and access control module necessary to mediate setting processing.

Then, as shown in FIG. 4A, the field device 11m connects to the network and performs parameter request R1m and reception of message response R2m through the access point 12 to perform automatic setting processing.

With this, as shown in FIG. 4B, the field device 11m participates in the network as well as performing the software module to mediate the setting processing of the different device. Then, the field device 11m becomes an access point 12m including both the function as the field device and the mediation function of the setting processing of other field device 11 and then operates as the access point 12m. In other words, when other field device 11n is connected, the access point 12m (=field device 11m) establishes a communication link with the device 11n and transfer of parameter request R1n and transfer of message response R2n can be performed between the device 11n and the provisioning server 21.

As described above, according to the network system of the first embodiment and the setting method of the field device 11 of the first embodiment, by registering setting information of a large number of field devices 11 in the provisioning server 21, the setting of each field device 11 can be performed through the network. Therefore, the advantage of substantially reducing labor and time necessary for device setting can be obtained.

Also, since the field device 11 before setting processing can perform setting processing by connecting to communicate with the access point 12 previously participating in the network, the field device 11 does not need to previously set a unique network parameter to connect to the network normally. The advantage of being able to set the network parameter by downloading the network parameter from the server through the network can be obtained.

Also, when the setting information is downloaded from the provisioning server 21, the access point 12 performs access control so that access to the provisioning server 21 is not concentrated, and thus even when transfer request (parameter request) of setting information is sent from a large number of field devices 11 at once, a disadvantage such as excessive burden on the provisioning server 21 or the network path can be avoided.

### Second Embodiment

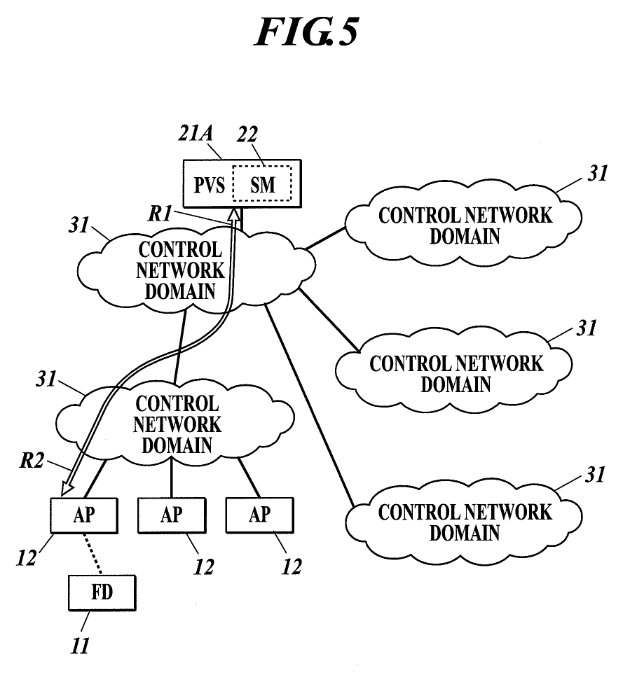

FIG. 5 is a diagram showing an example of a structure of a network system according to a second embodiment.

The network system of the second embodiment performs authentication, etc., in the setting processing of the newly connected field device 11 in order to further ensure security and stability of the network system. Detailed description of the structure similar to the first embodiment is omitted.

The network system of this embodiment includes, along with a provisioning server 21A to perform management and provision of setting information, a security manager 22 as an authentication server to perform authentication, etc. of the field device 11 in the setting processing of the field device 11. The security manager 22 can be configured to be embedded in the provisioning server 21A as shown in FIG. 5, or can be configured to be a different server device from the provisioning server 21A.

The security manager 22 is composed of software performed by the CPU of the server device. The software includes an authentication module to perform management of information for authentication of a plurality of field devices 11 to participate in the network and to perform authentication processing and a processing program to permit transfer of setting information to the provisioning server 21 after authentication. Also, the security manager 22 also includes a function to provide key data (join key) necessary for the field device 11 after setting processing to participate in the network, or if each field device 11 is a structure which performs cipher communication through the network, to provide cipher key or cipher group data (called cipher suite: list of encryption algorithm, etc.) necessary for cipher communication.

Incidentally, in the network system of the present embodiment, the security of the communication path from each access point 12 to the provisioning server 21A is ensured. For example, only a dedicated line is involved or cipher communication with ensured security is performed. When the provisioning server 21A and the security manager 22 are provided in different devices, the security of the communication path between the devices is also ensured.

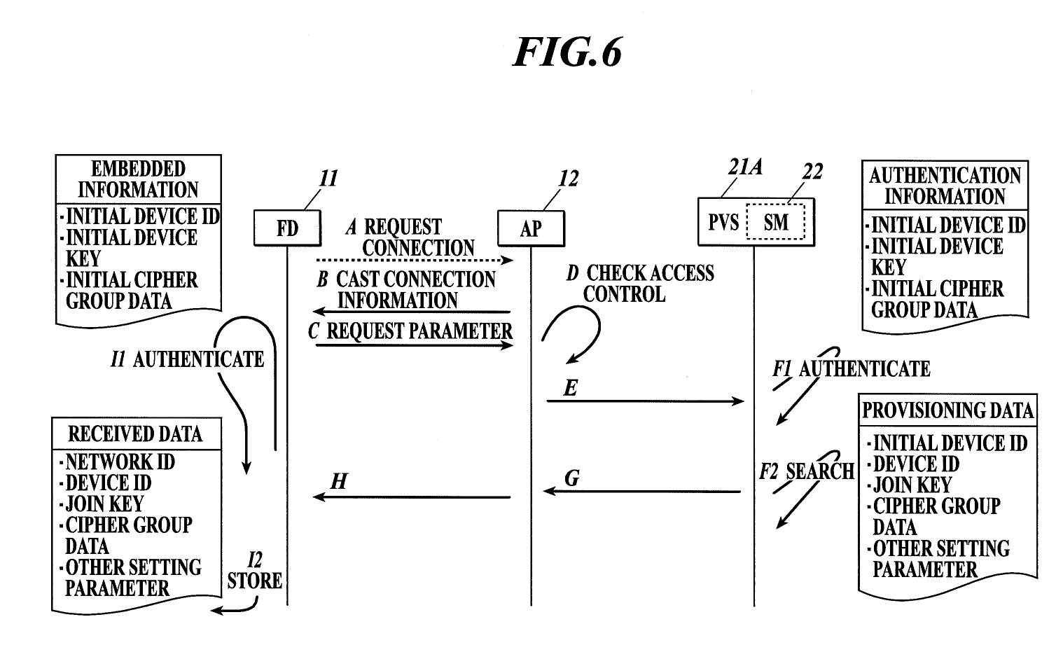

FIG. 6 is a sequence diagram showing a flow of operation from when a field device 11 is newly connected to the network to when setting information is reflected to the field device 11 according to the network system of the second embodiment.

In the second embodiment, the following initial information (embedded information shown in FIG. 6) is set in the field device 11 which is to participate in the network. In other words, initial information including initial device ID to indentify each device in setting processing, key data to be the initial device key to receive authentication in setting processing, initial cipher program or initial cipher group data (list of supported encryption algorithm, etc.) necessary for encryption of sent data in setting processing and authentication processing. As for the key data, in a common key system, key data common to the security manager 22 is applied and in a public key system, a key pair signed by a reliable authentication organization is applied. Such initial information is stored in a predetermined region of the nonvolatile memory of the field device 11.

Also, security manager 22 is previously registered with data for authentication by computation processing of whether or not the initial device key sent from the field device 11 is registered, database comparison, etc., and data for cryptographic processing corresponding to the initial cipher group data of the field device 11.

In the network system of the second embodiment, for example, when an operator provides the field device 11 at a predetermined position of the plant facility, connects the field device 11 to the network and turns the power on, the processing operation of A to I2 shown in FIG. 6 is performed and the setting processing of the field device 11 is performed automatically.

First, as for A, when the field device 11 connects to the network, the automatic link module of the field device 11 operates to send from the field device 11 to an unspecified device on the network a connection request to establish a communication link with the access point 12. The connection request can be omitted by using a communication method where the access point 12 periodically sends initial network connection information to unspecified devices without waiting for a connection request.

As for B, when the above described connection request is received, or by a periodical operation, the access point 12 sends out initial network connection information to the unspecified large number of devices on the network. Then, when the field device 11 receives the network connection information, the field device 11 establishes a communication link based on the connection information to be able to communicate data with the access point 12.

As for C, when the communication link with the access point 12 is established, the field device 11 sends a transfer request (parameter request) of the setting information with its initial device ID to the access point 12. Also, in the transfer request, the field device 11 encrypts the initial device key with the algorithm shown in the initial cipher group data and also includes the encrypted initial device key and the initial cipher group data in the sent data to be sent.

As for D, when the access point 12 receives the above described parameter request, the access point 12 performs the access control such as restricting concentrated access by the above described access control module.

As for E, when it is the timing where it is possible to access to the server based on the above described access control, the access point 12 transfers the parameter request received from the field device 11 to the provisioning server 21A through the network (parameter request R1 shown in FIG. 5). When the security manager 22 is included in a different server device, the parameter request is also sent to the security manager 22.

As for F1, when the provisioning server 21A receives the above described parameter request, first, the provisioning server 21A extracts the information concerning authentication (authentication information shown in FIG. 6: initial device ID, initial device key, initial cipher group data) from the server and sends the information to the security manager 22. The security manager 22 performs decoding processing on the encrypted data with the authentication information as well as authenticate whether the initial device ID and the initial device key are registered. Then, when they are authenticated the processing advances to the next step, however when they are not authenticated, the processing from then on is stopped and the field device 11 which cannot be authenticated is prevented from participating in the network.

As for F2, after the authentication information is confirmed, next, the provisioning server 21A searches the setting information data base based on the initial device ID and extracts setting information corresponding to the initial device ID.

As for G, when the setting information is extracted, the provisioning server 21A creates a response message including the setting information as provisioning data and sends the response message to the access point 12 (message response R2 shown in FIG. 5). The provisioning data includes, for example, initial device ID showing a transfer destination, device ID to be identification information in participation and operation of the network, operation parameter of the application, network parameter necessary for network connection, key data (join key) necessary to participate in the network system or cipher group data necessary to perform cipher communication in the network system are included. The cipher group data is different from the initial cipher group data which the field device 11 has as initial information. Also, the provisioning server 21A or the inner security manager 22 includes encrypted authentication data in the response message based on the initial encryption group data.

As for H, the access point 12 sends the above described response message to the corresponding field device 11 based on the initial device ID included as the destination in the response message.

As for I1, when the field device 11 receives the above described response message, first, the field device 11 decodes the authentication data from the provisioning server 21A included in the response message based on its initial cipher group data and authenticates whether the response data is really sent from the provisioning server 21A.

As for I2, when the authentication is performed, then, the field device 11 reads out the setting information included in the response message and reflects the information to its setting status. With this, the field device 11 can communicate with other devices through the network, and can operate the device function in coordination with other devices.

When the plurality of field devices 11 are newly connected to the network, the above described processing operation of A to I2 is performed for each field device 11, and with this, the setting processing of the plurality of field devices 11 are automatically performed sequentially. Then, the plurality of field devices 11 are in a status to be able to operate on the network.

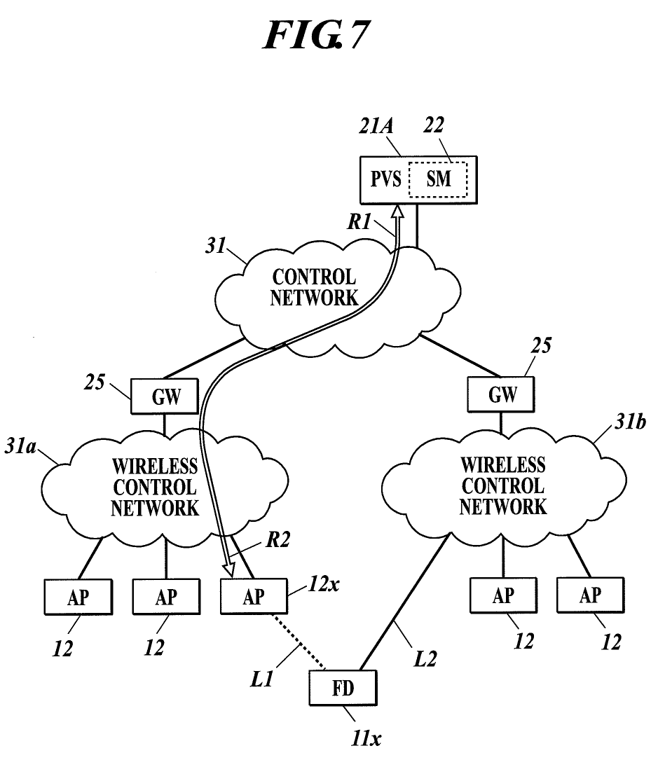

FIG. 7 is an explanatory diagram showing an example of switching of a connection status between the field device 11 and the network according to the second embodiment.

Also, in the network system of the second embodiment, as shown in FIG. 7, when the field device 11x reflects the network parameter sent from the provisioning server 21A to its setting status, the communication path L1 first established for setting processing is released and a different new communication path L2 is established and connection to the network is performed through the new communication path L2. The communication path L1 before setting processing and the communication path L2 after setting processing may be changed across different network regions 31a, 31b.

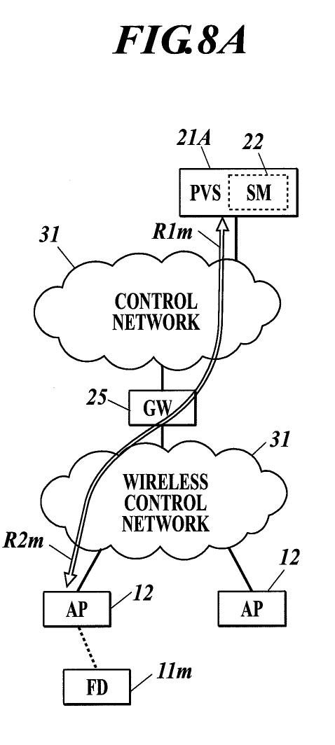

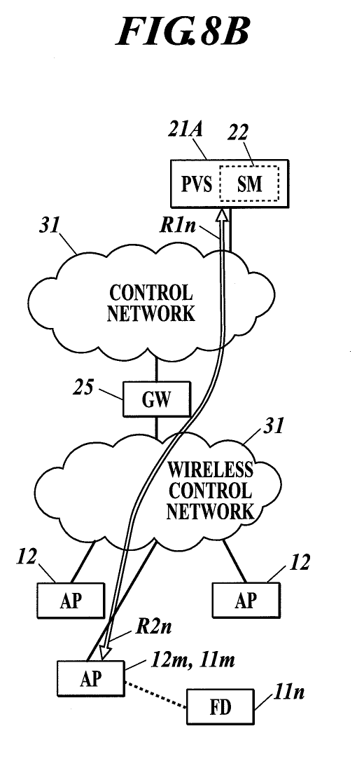

FIG. 8A and FIG. 8B are explanatory diagrams showing an example of an operation when a function as an access point is added to the field device 11 in the second embodiment.

Also, in the network system of the second embodiment, by embedding software in the field device 11 to function as the access point 12, as shown in FIG. 8A, when the field device 11m connects to the network and performs parameter request R1m and reception of message response R2m through the access point 12 to perform automatic setting processing, then, as shown in FIG. 8B, the field device 11m can operate as the access point 12m with both the function as the field device and the mediation function of the setting processing of other field device 11n.

As described above, according to the network system of the second embodiment and the setting method of the field device 11 of the third embodiment, similar to the first embodiment, the advantage of substantially reducing the labor and time necessary for device setting can be obtained by setting processing through the network, and also, the advantage of reducing the burden on the provisioning server 21, security manager 22 and network path can be obtained by access control by the access point 12.

Further, according to the network system of the second embodiment and the setting method of the field device 11 of the second embodiment, when a new field device 11 is connected to the network and setting information is downloaded from the provisioning server 21A, authentication of whether the field device 11 is registered is performed by the security manager 22, and thus high communication security can be maintained consistently from when the parameter setting processing is performed to when normal operation is performed. In other words, a device which is not registered to the network being connected by mistake can be prevented. Also, involvement of improper processing such as alteration of content of parameter request or message response can be prevented.

### Third Embodiment

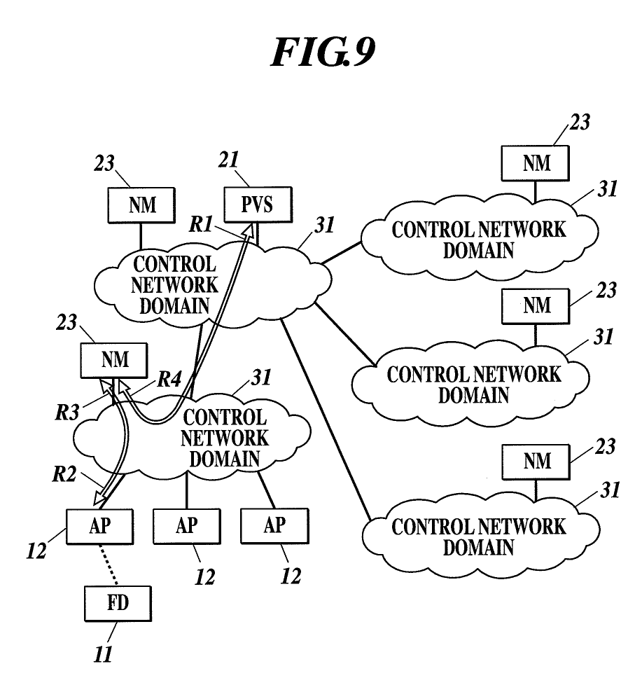

FIG. 9 is a diagram showing an example of a structure of a network system according to the third embodiment.

The network system of the third embodiment allows a network parameter dynamically determined when the field device 11 is connected to the network to be set to the field device 11 by setting processing through the network. Detailed description of the structure similar to the first embodiment is omitted.

In the network system of the third embodiment, other than the provisioning server 21 to perform provision of setting information, the network system of the third embodiment is provided with a network management server (NM: network manager) 23 to perform management of the network and allocation of the dynamic network parameter.

When a plurality of network regions 31, 31 and so on each independently manage a dynamic network parameter, the network management server 23 is provided in each network region 31. Incidentally, when the network management server 23 is in the same network region 31 as the provisioning server 21, the function as the network management server 23 can be added to the provisioning server 21 and a structure with the two functions can be implemented on the same server device.

The network management server 23 performs general management of network information of each network region 31 and management of network parameter of each device. For example, various parameters to perform communication is managed such as network address and path information of each device, management of band, when the network is a wireless network, allocation of time slot in time division multiplex (TDM) communication and hopping pattern in a frequency hopping (FH) method.

Also, the network management server 23 of the present embodiment is provided with the function to be dynamically allocated to the field device 11 when there is a transfer request (parameter request) of setting information from the newly connected field device 11 or to transfer a unique network parameter independently set for each network region 31 by adding the unique network parameter to the response message from the provisioning server 21.

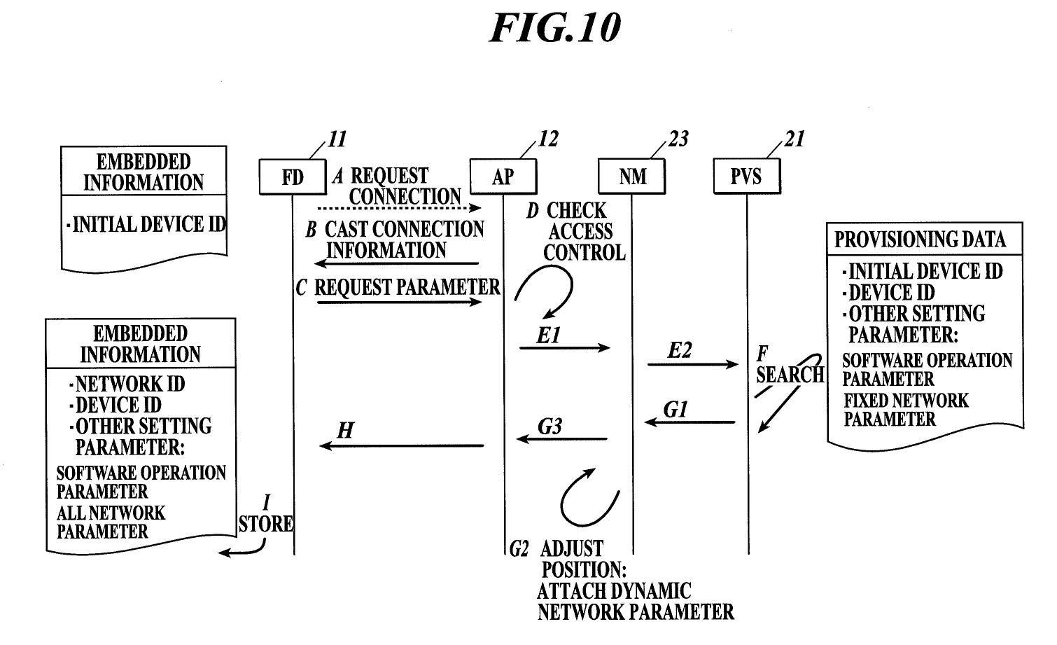

FIG. 10 is a sequence diagram showing a flow of operation from when a field device 11 is newly connected to the network to when setting information is reflected to the field device 11 according to the third embodiment.

In the network system of the third embodiment, for example, when an operator provides the field device 11 at a predetermined position of the plant facility, connects the field device 11 to the network and turns the power on, the processing operation of A to I shown in FIG. 10 is performed and the setting processing of the field device 11 is performed automatically.

First, as for A, when the field device 11 connects to the network, the automatic link module of the field device 11 operates to send from the field device 11 to an unspecified device on the network a connection request to establish a communication link with the access point 12. The connection request can be omitted by using a communication method where the access point 12 periodically sends initial network connection information to unspecified devices without waiting for a connection request.

As for B, when the above described connection request is received, or by a periodical operation, the access point 12 sends out initial network connection information to the unspecified large number of devices on the network. Then, when the field device 11 receives the network connection information, the field device 11 establishes a communication link based on the connection information to be able to communicate data with the access point 12.

As for C, when the communication link with the access point 12 is established, the field device 11 sends a transfer request (parameter request) of the setting information with its initial device ID to the access point 12.

As for D, when the access point 12 receives the above described parameter request, the access point 12 performs the access control such as restricting concentrated access by the above described access control module.

As for E1, according to the above described access control when the access timing comes, the access point 12 transfers the parameter request including the initial device ID received from the field device 11 to the network management server 23 through the network (parameter request R3 shown in FIG. 9). When the network management server 23 is in the same network region 31, the parameter request is transferred to this network management server 23.

As for E2, the network management server 23 transfers the parameter request sent from the access point 12 to the provisioning server 21 (parameter request R1 shown in FIG. 9).

As for F, when the provisioning server 21 receives the above described parameter request, the provisioning server 21 performs a search processing in the setting information data base based on the initial device ID and extracts setting information corresponding to the initial device ID.

As for G1, when the setting information is extracted, the provisioning server 21 creates a response message including the setting information as provisioning data and sends the response message to the network management server 23 (message response R4 shown in FIG. 9). The provisioning data includes, for example, initial device ID showing a transfer destination, device ID to be identification information in participation and operation of the network, and other parameters such as operation parameter of the application, network parameter necessary for network connection which is fixed and can be determined when the system is designed, and the like.

As for G2, the network management server 23 performs management processing of adding the newly connected field device 11 to the network and also adds to the response message the network parameter dynamically assigned to the field device 11 (for example, network address, path information, etc.) and the network parameter unique to the network region 31 (for example, setting parameter of TDM communication or FD method communication).

As for G3, when the network parameter is added, the network management server 23 transfers the response message to the access point 12 (message response R2 shown in FIG. 9).

As for H, the access point 12 sends the response message to the corresponding field device 11 based on the initial device ID included in the response message.

As for I, the field device 11 reads out the setting information included in the response message and reflects the information to its setting status. With this, the ID of the field device is rewritten from the initial device ID to the device ID assigned by the provisioning server 21 and also the network parameter is assigned to the communication module and the operation parameter of the software is assigned to each software. With this, the field device 11 can communicate with other devices through the network, and can operate the device function in coordination with other devices.

When the plurality of field devices 11 are newly connected to the network, the above described processing operation of A to I is performed for each field device 11, and with this, the setting processing of the plurality of field devices 11 are automatically performed sequentially. Then, the plurality of field devices 11 are in a status to be able to operate on the network.

### [Modification]

As for the network parameter, there is a parameter where the optimum value can be determined only after the field device 11 is actually connected to the network. For example, in wireless connection, when a plurality of communication paths or a plurality of communication frequency bands can be used, as for determining the parameter for these communication paths or communication frequency bands, the optimum value can be set better by determining by comparing the communication sensitivity of each communication path and each communication frequency band. Also, in wired communication where the network structure is not fully grasped, a list of the router which exists in the communication link where the field device 11 is connected needs to be collected and a default router of the field device 11 needs to be determined.

In such a network structure, a more suitable network parameter setting can be performed by adding the following function to the field device 11 and the network management server 23.

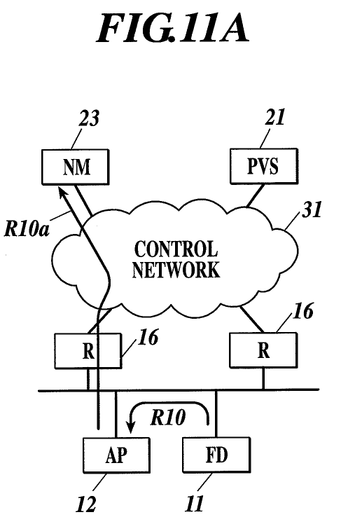

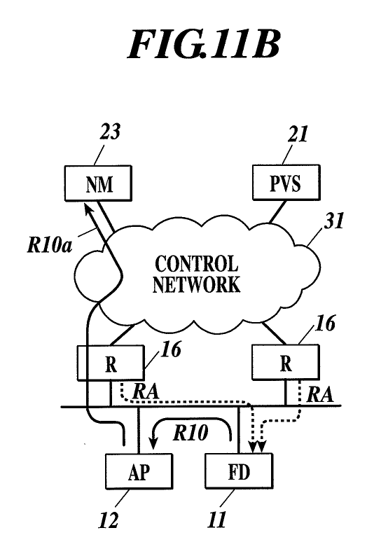

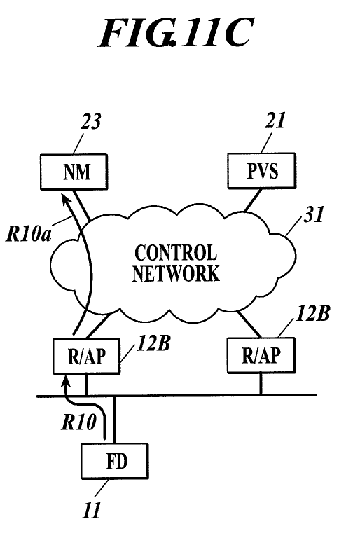

FIG. 11A to FIG. 11C are explanatory diagrams showing an example of collection pattern of router list information by the field device 11 in a network of wired communication. FIG. 11A to FIG. 11C are the first to third patterns, respectively.

In the pattern of FIG. 11A, the access point 12 previously collects a list of the router which is in the link where the access point 12 is connected, and when the field device 11 is wiredly connected to the link and communicable with the access point 12, the access point 12 notifies the list of the router to the network management server 23.

For example, a parameter request R10 is sent from the field device 11 to the access point 12 and when a parameter request R10a is transferred from the access point 12 to the network management server 23, the access point 12 adds the previously collected router list information to the parameter request R10a and transfers the parameter request R10a.

With this, the network management server 23 determines the parameter of the default router of the field device 11 (in other words, the routing path of the field device 11) based on the router list as necessary and this can be added to the response message from the provisioning server 21.

In the pattern of FIG. 11B, the router 16, 16 broadcasts its router information RA, RA in the link, such as for example, a network structure supporting Internet Protocol Version 6 (IPv6). In such structure, when the field device 11 is wiredly connected to the link, the broadcast router information RA, RA is collected and when the parameter request R10 is sent to the access point 12, the router list information can be added to the parameter request R10.

Then, when the access point 12 transfers to the network management server 23 the parameter request R10a with the router list information added thereto, the network management server 23 determines the parameter of the default router of the field device 11 as necessary and this is added to the response message from the provisioning server 21.

In the pattern of FIG. 11C, the access point 12B is the router. In such a structure, similar to the above described first pattern and second pattern, the router list information in the link can be collected as necessary and can be sent to the network management server 23.

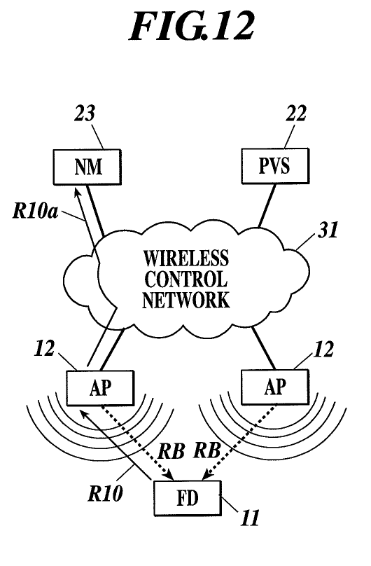

FIG. 12 is an explanatory diagram showing an example of collection pattern of information of communication sensitivity by the field device 11 in a network of wireless communication.

In the pattern of FIG. 12, the field device 11 collects information of the signal strength and sends the information to the network management server 23 so that the field device 11 can perform communication processing at a stable signal strength in the wireless network.

In other words, when the field device 11 is connected to the wireless network and the broadcast RB, RB of the initial network connection information is performed from each access point 12, 12, the field device 11 performs reception of the broadcast RB, RB and so on from all of the access points 12, 12 and so on, and the field device 11 collects the network address and the value of the signal strength of each access point 12, 12 and so on. Then, the collected information is added to the parameter request R10, R10a and is transferred to the network management server 23 through the access point 12.

With this, the network management server 23 determines the optimum signal frequency band or the communication path for the field device 11 from the signal frequency band of the access point 12 where the signal strength is large, the provided position of the access point 12, etc., and the network parameter can be included in the response message from the provisioning server 21.

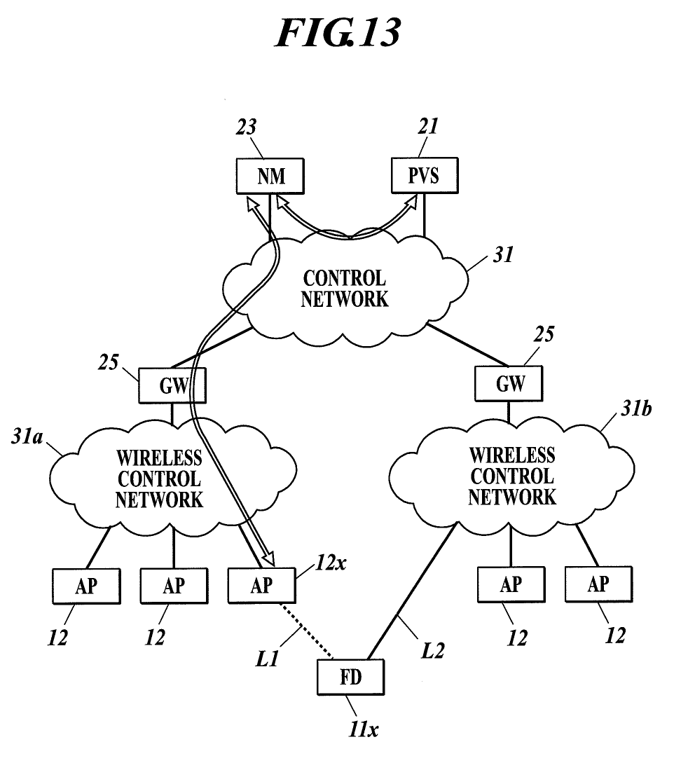

FIG. 13 is an explanatory diagram showing an example of switching of a connection status between the field device 11 and the network according to the third embodiment.

Incidentally, in the network system of the third embodiment, as shown in FIG. 13, when the field device 11x reflects the network parameter sent from the provisioning server 21 to its setting status, the communication path L1 first established for setting processing is released and a different new communication path L2 is established and connection to the network is performed through the new communication path L2.

Also, as shown in FIG. 13, even when there are a plurality of network regions 31, 31a, 31b, when there is a network management server 23 to perform comprehensive network information management of the plurality of network regions 31, 31a, 31b, the communication path L1 before setting processing and the communication path L2 after setting processing may be changed across different network regions 31a, 31b by the network parameter determined by the network management server 23.

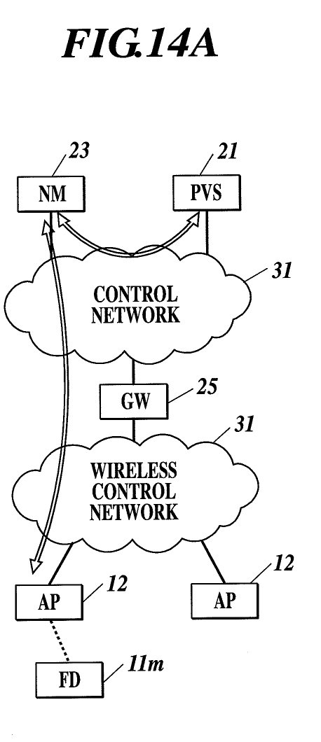

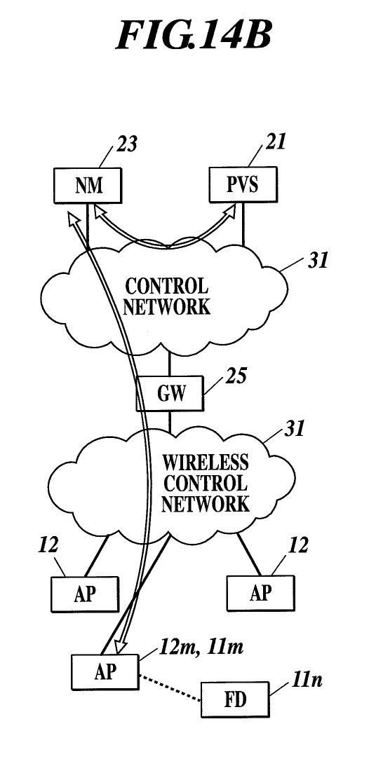

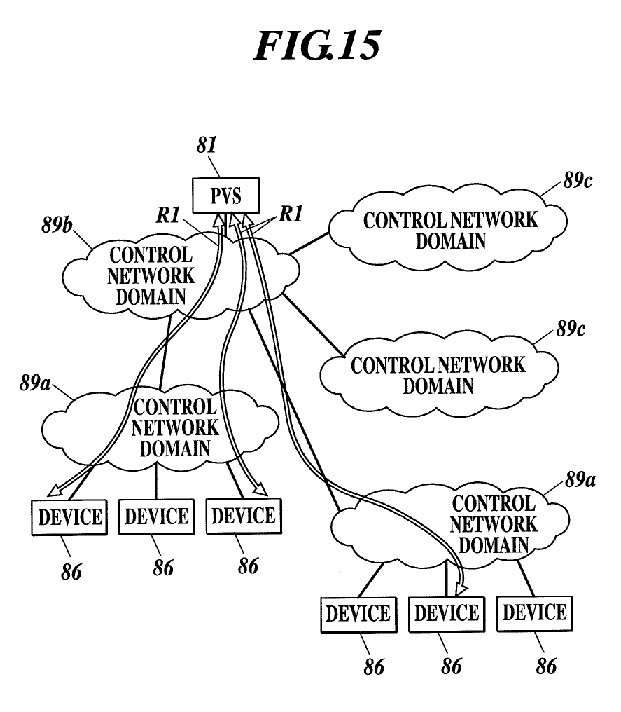

FIG. 14A and FIG. 14B are explanatory diagrams showing an example of an operation when a function as an access point is added to the field device 11 according to the third embodiment.

Also, in the network system of the third embodiment, by embedding software in the field device 11 to function as the access point 12, as shown in FIG. 14A, when the field device 11m connects to the network and performs parameter request and reception of message response through the access point 12 to perform automatic setting processing, then, as shown in FIG. 14B, the field device 11m can operate as the access point 12m with both the function as the field device and the mediation function of the setting processing of other field device 11n.

As described above, according to the network system of the third embodiment and the setting method of the field device 11 of the third embodiment, similar to the first embodiment, the advantage of substantially reducing the labor and time necessary for device setting can be obtained by setting processing through the network, and also, the advantage of reducing the burden on the provisioning server 21, network management server 23 and network path can be obtained by access control by the access point 12.

Also, according to the network system of the third embodiment and the setting method of the field device 11 of the third embodiment, even if the network parameter is dynamically set so that the network parameter cannot be set beforehand when the system is designed, etc., or the network parameter is determined or its optimum value is found when the field device 11 is provided, the network management server 23 dynamically determines them and adds them to the setting information of the provisioning server 21 and sends them to the field device 11. Consequently, the advantage of enabling automatic setting through the network can be achieved for these network parameters also.

Incidentally, the present invention is not limited to the above described embodiments and various modifications are possible. For example, in the above described first to third embodiments, an example of a network system composed of field devices provided in a plant facility, etc., is shown, however, the type of network system and the type of device that compose the network system are not limited to those of the embodiments shown. Also, as for the communication method applied to the network system and the communication method of the communication link established between the access point and the field device in the setting processing, various communication methods of the known art can be applied or a newly established dedicated communication method can be applied. Other details specifically shown in the embodiments such as content of the information included in the parameter request and the message response can be modified without leaving the scope of the invention.

According to an aspect of the preferred embodiments, there is provided a network system where a plurality of devices operate by performing communication with each other through a network, the network system including:

a provisioning server to provide setting information to a device newly connected to a network; and

a mediating device to mediate information transmission between the device newly connected to the network and other device, wherein

the mediating device includes:
a communication function to communicate with the device newly connected to the network;
an access control function to restrict access to the other device to a certain amount or less; and
a data transfer function to transfer data by mediating the device newly connected to the network and the other device, and

when there is a transfer request of the setting information from the device newly connected to the network, the mediating device sends the transfer request to the provisioning server by restricted access based on the access control function, and when the setting information is sent from the provisioning server, the mediating device transfers the setting information to the device newly connected to the network.

Preferably, in the network system,

the device which can participate in the network is provided with:
a data storage section to store an initial device ID to indentify the device;
a communication function to communicate with the mediating device;
a data request function to send the initial device ID and the transfer request of the setting information by the communication function; and
a setting change function to change its setting with the setting information when the setting information is received, and

the provisioning server is provided with:
a setting information database where an initial device ID to identify the device which can participate in the network and setting information corresponding to the device are accumulated corresponding to each other;
a searching section to search setting information corresponding to the initial device ID from the setting information database when the initial device ID and the transfer request of the setting information is received; and
a responding section to send the setting information searched by the searching section according to the transfer request.

Preferably, the network system further includes an authentication server including authentication information to allow the device newly connected to participate in the network, wherein

when there is an authentication request to participate in the network from the device newly connected to the network, the mediating device sends the authentication request to the authentication server by restricted access based on the access control function, and when the newly connected device is authenticated by the authentication server, the setting information can be sent from the provisioning server to the device.

Preferably, in the network system,

the device which can participate in the network is provided with an initial encryption module and initial cipher key to encrypt data to send and receive the data to and from the authentication server; and

the authentication server receives encrypted authentication information from the device newly connected to the network to authenticate the device.

Preferably, the network system further includes a network management server to perform management of a network structure and which can provide a network parameter necessary to perform sending and receiving of data to the device newly connected to the network with the network, wherein

when there is a transfer request of the setting information from the device newly connected to the network, the mediating device sends the transfer request to the network management server by restricted access based on the access control function, and the network management server adds the network parameter to the setting information to be transferred through the mediating device to the device newly connected to the network.

Preferably, in the network system, when the device newly connected to the network can be connected to the network by a plurality of paths, the network management server collects information concerning the plurality of paths, determines the network parameter based on the information and adds the network parameter to the setting information.

Preferably, in the network system,

the device which can participate in the network includes a function module to operate as the mediating device; and

when the device receives the setting information from the provisioning server and participates in the network reflected with the setting information, the device activates the function module to operate as the mediating device also.

According to another aspect of the preferred embodiments, there is provided a device setting method in a network system where a plurality of devices operate by performing communication with each other through a network, the device setting method which performs setting to allow a newly connected device to participate in the network with automatic control operation by the newly connected device, provisioning server to provide setting information of the device, and mediating device to mediate information transmission between the device and the provisioning server, the device setting method including:

connecting the device newly connected to the network communicably with the mediating device previously connected to the network;

performing transfer request of the setting information by the device communicably connected to the mediating device;

sending the transfer request of the setting information to the provisioning server by the mediating device in a status restricting the access amount to a certain amount or less;

sending the setting information by the provisioning server through the mediating device to the device based on the transfer request; and

changing a setting status based on the setting information by the device which receives the setting information through the mediating device.

According to the above described aspects, the provisioning server sends the setting information to each device through the network and each device performs the setting. Consequently, an advantage of substantially reducing labor and time necessary for setting processing of the device and highly reliable setting processing can be achieved. Also, each device performs the transfer request of the setting information through the mediating device to the provisioning server, and the mediating device restricts access to the provisioning server to a certain amount or less. Consequently, the access concerning the transfer request to the provisioning server can be distributed and the advantage of not providing excess burden on the network path or the provisioning server can be obtained.

Also, since the network management server performs the setting of the network parameter, even if the value of the network parameter cannot be predicted until the device is actually provided, the network management server collects information concerning them and determines the parameter. Consequently, the advantage of enabling setting of the optimum network parameter for each device can be obtained.

The entire disclosure of Japanese Patent Application No. 2008-133745 filed on May 22, 2008 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A network system where a plurality of devices operate by performing communication with each other through a network, the network system comprising:
a provisioning server to provide setting information to a device newly connected to a network; and
a mediating device to mediate information transmission between the device newly connected to the network and other device, wherein
the mediating device includes:
a communication function to communicate with the device newly connected to the network;
an access control function to restrict access to the other device to a certain amount or less; and
a data transfer function to transfer data by mediating the device newly connected to the network and the other device, and
when there is a transfer request of the setting information from the device newly connected to the network, the mediating device sends the transfer request to the provisioning server by restricted access based on the access control function, and when the setting information is sent from the provisioning server, the mediating device transfers the setting information to the device newly connected to the network.

2. The network system according to claim 1, wherein
the device which can participate in the network is provided with:
a data storage section to store an initial device ID to indentify the device;
a communication function to communicate with the mediating device;
a data request function to send the initial device ID and the transfer request of the setting information by the communication function; and
a setting change function to change its setting with the setting information when the setting information is received, and
the provisioning server is provided with:
a setting information database where an initial device ID to identify the device which can participate in the network and setting information corresponding to the device are accumulated corresponding to each other;
a searching section to search setting information corresponding to the initial device ID from the setting information database when the initial device ID and the transfer request of the setting information is received; and
a responding section to send the setting information searched by the searching section according to the transfer request.

3. The network system according to claim 1, further comprising an authentication server including authentication information to allow the device newly connected to participate in the network, wherein
when there is an authentication request to participate in the network from the device newly connected to the network, the mediating device sends the authentication request to the authentication server by restricted access based on the access control function, and when the newly connected device is authenticated by the authentication server, the setting information can be sent from the provisioning server to the device.

4. The network system according to claim 3, wherein
the device which can participate in the network is provided with an initial encryption module and initial cipher key to encrypt data to send and receive the data to and from the authentication server; and
the authentication server receives encrypted authentication information from the device newly connected to the network to authenticate the device.

5. The network system according to claim 1, further comprising a network management server to perform management of a network structure and which can provide a network parameter necessary to perform sending and receiving of data to the device newly connected to the network with the network, wherein
when there is a transfer request of the setting information from the device newly connected to the network, the mediating device sends the transfer request to the network management server by restricted access based on the access control function, and the network management server adds the network parameter to the setting information to be transferred through the mediating device to the device newly connected to the network.

6. The network system according to claim 5, wherein when the device newly connected to the network can be connected to the network by a plurality of paths, the network management server collects information concerning the plurality of paths, determines the network parameter based on the information and adds the network parameter to the setting information.

7. The network system according to claim 1, wherein
the device which can participate in the network includes a function module to operate as the mediating device; and
when the device receives the setting information from the provisioning server and participates in the network reflected with the setting information, the device activates the function module to operate as the mediating device also.

8. A device setting method in a network system where a plurality of devices operate by performing communication with each other through a network, the device setting method which performs setting to allow a newly connected device to participate in the network with automatic control operation by the newly connected device, provisioning server to provide setting information of the device, and mediating device to mediate information transmission between the device and the provisioning server, the device setting method comprising:
connecting the device newly connected to the network communicably with the mediating device previously connected to the network;
performing transfer request of the setting information by the device communicably connected to the mediating device;
sending the transfer request of the setting information to the provisioning server by the mediating device in a status restricting the access amount to a certain amount or less;
sending the setting information by the provisioning server through the mediating device to the device based on the transfer request; and
changing a setting status based on the setting information by the device which receives the setting information through the mediating device.
